(19) United States
(12) Patent Application Publication
(10) Pub. No.: US 2020/0125868 A1
(43) Pub. Date: Apr. 23, 2020

(54) METHOD AND SYSTEM FOR DETECTING A PARKING VEHICLE

(71) Applicant: PARKAM (ISRAEL) LTD, Tel Aviv (IL)

(72) Inventors: Asaf NAAMANI, Shapira (IL); Ori ATTAR, Modi'in (IL)

(21) Appl. No.: 16/623,102

(22) PCT Filed: Jun. 10, 2018
(86) PCT No.: PCT/IL2018/050631

§ 371 Date: Dec. 16, 2019

(30) Foreign Application Priority Data
Jun. 15, 2017 (IL) 252956

(51) Int. Cl. G06K 9/00; G06K 9/32; G05D 1/02; G08G 1/14

(52) U.S. Cl. CPC G06K 9/00812; G06K 9/3241; G08G 1/148; G08G 1/142; G08G 1/146; G05D 1/0212

(57) ABSTRACT

The present invention relates to a system for identifying a vehicle approaching a parking space, from one or more video images while cross-referencing the video-image based identification with readings from sensors of a mobile device present within the vehicle, wherein after identification of the vehicle, it is tracked until reaching a parking space, during parking in the parking space and until the vehicle leaves the parking space.

### FIELD OF THE INVENTION

The present invention relates to the field of vehicle detection. More particularly, the invention relates to a system for detecting a vehicle approaching, parking and leaving a parking space.

### BACKGROUND OF THE INVENTION

Video based parking systems allow, among others, charging the owner of a vehicle for parking. In order to automatically detect when a vehicle begins parking and when the vehicle ends parking, there is need in identifying the vehicle before reaching the parking space.

When attempting to identify a vehicle from a group of vehicles merely by using video images, a system might confuse the subject vehicle from other vehicles. This problem escalates in crowded areas wherein numerous vehicles of the same model are likely to exist. Attempting to provide identify a vehicle based merely on video images can result in erroneous identification, let alone failure of the system.

It is therefore an object of the present invention to provide a system capable of identifying a vehicle from video images with the aid of other identification mediums.

It is another object of the invention to provide a system capable of tracking a parking vehicle and determining whether or not the vehicle is still parking.

Other objects and advantages of this invention will become apparent as the description proceeds.

### SUMMARY OF THE INVENTION

The present invention relates to a method for detecting and tracking a traveling vehicle, comprising:
a) receiving, at a remote server, readings from one or more sensors of a mobile device that are relative to travel-pattern features of said traveling vehicle, including geolocation data;
b) processing, at the remote server, the received readings as to generate travel-pattern diagnosis of said traveling vehicle;
c) receiving images, from one or more cameras, of a driving area in accordance with the geolocation of said traveling vehicle, wherein said one or more cameras are distributed throughout said driving area;
d) identifying vehicles that appear in said received images by extracting visual descriptor features of said appeared vehicles and detecting travel-pattern features of said appeared vehicles; and
e) comparing the detected travel-pattern features of one or more appeared vehicle with the generated travel-pattern diagnosis of said traveling vehicle for finding travel-pattern features of a vehicle which match the travel-pattern diagnosis, whereupon detection of a vehicle whose travel-pattern features match the travel-pattern diagnosis the vehicle is labeled and tracked.

According to an embodiment of the invention, the readings from the one or more sensors of the mobile device are received whenever the traveling vehicle approaches a predetermined destination.

According to an embodiment of the invention, each camera has a field of view that includes at least a street, a road or a way of the driving area.

In another aspect, the present invention relates to a system for detecting and tracking a traveling vehicle, comprising:
a) a software application for mobile devices adapted to obtain readings from sensors of the mobile device and to send the readings to a remote server;
b) one or more video cameras distributed throughout a driving area, each camera having a field of view, the field of view comprising at least a street, a road or a way of the driving area, the one or more cameras comprising communication hardware for transmitting images to a remote server; and
c) a remote server comprising:
   i. communication hardware for communicating with mobile devices;
   ii. an image processor being a software module for identifying a vehicle from images received from one or more cameras, the image processor comprising a visual descriptor software module adapted to extract visual descriptor features of vehicles and an object tracker adapted to detect travel-pattern features of vehicles;
   iii. a Geographic Information System (GIS) being a software module adapted to recognize the geolocation of vehicles;
   iv. a memory unit;
   v. a comparison module being a software module adapted to compare data from a plurality of sources; and
   vi. a processing unit adapted to process non-contextual data and generate contextual data which is of significance to vehicle detection.
wherein upon activation of the software application by a user, sensors of the mobile device are activated and readings of the sensors are transferred to the remote server, the remote server receives the sensor readings, processes the readings by the processing unit and generates travel-pattern diagnosis; and wherein the remote server detects the geolocation of the vehicle from the sensor readings and accordingly obtains images from one or more video cameras located in the vicinity of the vehicle, after which the visual descriptor generates travel-pattern features of vehicles from the images, and the travel-pattern features are stored on the memory unit; and wherein the travel-pattern features of each vehicle are searched, by the comparison module, for travel-pattern features of a vehicle which match the travel-pattern diagnosis, whereupon detection of a vehicle whose travel-pattern features match the travel-pattern diagnosis the vehicle is labeled and tracked by the object tracker.

In yet another aspect, the present invention relates to a system for detecting and tracking a vehicle approaching a parking space and parking in a parking space, comprising:
a) the system of claim 4 adapted to detect and track a traveling vehicle; and
b) one or more video cameras distributed throughout one or more parking areas, each camera having a field of view, the field of view comprising at least a portion of a parking area, the one or more cameras comprising communication hardware for transmitting images to the remote server;
   wherein the field of view of the one or more video cameras distributed throughout the driving area comprises at least a route to the parking area; and wherein the labeled vehicle is continuously tracked until parking reaching a parking space; and wherein images of the parking space are obtained while the vehicle is parking and online visual descriptor features of the parking space extracted from the images are compared online to periodically updated visual descriptor reference features of the vehicle in the parking space, wherein inequality between the reference features and the online features yields the vehicle has left the parking space.

According to an embodiment of the invention, a vehicle is tracked until the vehicle leaves a parking space.

According to an embodiment of the invention, a vehicle is tracked until the user stops the software application.

According to an embodiment of the invention, a user is able to insert a request to the system, the request comprising directions to a vacant parking space; and wherein cameras and the processor of the system are utilized to detect a vacant parking space and the GIS is utilized to provide directions to the vacant parking space.

According to an embodiment of the invention, the sensors activated by the software application include at least GPS receiver and an accelerometer.

According to an embodiment of the invention, the parking state and location of a vehicle is utilized for charging a user a parking fee for parking in a pay-and-park parking space.

According to an embodiment of the invention, the parking state and location of a vehicle is utilized for detecting a vehicle parking in a prohibited parking space.

### BRIEF DESCRIPTION OF THE DRAWINGS

In the drawings:

FIG. 1 shows a flowchart describing the process of providing directions to a vacant parking space, according to an embodiment of the invention

FIG. 2 schematically illustrates a system for detecting a vehicle according to an embodiment of the invention.

### DETAILED DESCRIPTION OF THE INVENTION

The present invention relates to a system for identifying a vehicle approaching a parking space, from one or more video images while cross-referencing the video-image based identification with readings from sensors of a mobile device present within the vehicle, wherein after identification of the vehicle, it is tracked until reaching a parking space, during parking in the parking space and until the vehicle leaves the parking space.

Accordingly, the system comprises a software application for mobile devices, adapted to obtain readings from sensors of the mobile device and to send the readings to a remote server. The software application is further adapted to receive location and destination requests from a user of the mobile device, and to send the requests to the remote server. According to an embodiment of the invention, a user can connect to the system by activating the software application, whereas the user remains connected to the system as long as the software application is running, until the software application is stopped.

The system further comprises one or more video cameras that are distributed throughout a driving area and one or more video cameras that are distributed throughout a parking area. The driving area may be urban or suburban. The one or more video cameras are directed towards streets, roads and ways of the driving area, so that when activated the field of view of each camera includes at least a street, a road or a way. When activated, the one or more video cameras obtain images of the street, road, way or parking area. The images are sent, either by wireless or wired communication means, from the each camera to the remote server.

The remote server is adapted to receive readings and requests from the mobile device, and images from the one or more cameras. The remote server comprises an image processing module for identifying a vehicle from images received from one or more cameras. The image processing module comprises a visual descriptor module for extracting visual descriptor features of vehicles, such as the model and color of a vehicle, and an object tracking module for detecting travel-pattern features of vehicles, such as the velocity and direction of progress of a vehicle. The remote server further comprises a Geographic Information System (GIS) for relating the location of the vehicle to the location of one or more cameras in the vicinity of the vehicle. The remote server further comprises a memory unit. The remote server further comprises a comparator module adapted to compare vehicle travel-patterns extracted from video images with vehicle travel-patterns extracted from mobile device sensor readings.

The location of a vehicle is determined according to GPS readings that are sent from the mobile device to the remote server. The GPS readings are input to the GIS, which accordingly identifies one or more video cameras which are in the vicinity of the vehicle. The remote server accordingly activates one or more video cameras in order to track vehicles in the vicinity of the vehicle, assuming that the images contain the vehicle. The video images are processed by the image processing unit, which extracts visual descriptor features and travel-pattern features of vehicles in the images. These features, i.e. visual descriptor and travel-pattern, are stored in the local memory unit that is a part of the remote server.

Identifying a vehicle is further performed by processing readings from the sensors of the mobile device in order to realize travel-patterns of the vehicle. For instance an accelerometer of a mobile device can be used to realize direction of progress and the velocity of a vehicle, or a gyroscope of the mobile device can be used to realize the orientation of a vehicle.

The readings are processed and a travel-pattern diagnosis is generated. An exemplary pattern diagnosis is shown in table 1.

TABLE 1

| Instance | Duration | |
|---|---|---|
| Number | (seconds) | Description |
| 1 | 8.3 | Constant speed, 43 KPH, due North. |
| 2 | 4.2 | Deceleration to full stop at red traffic light, facing |
| | | North. |
| 3 | 24 | Full stop at traffic light, facing North. |
| 4 | 14.5 | Acceleration from full stop to 34 KPH, turning from |
| | | North to East. |

The travel-pattern diagnosis, as generated from the mobile device sensor readings is compared by the comparing module of the remote server to travel-pattern features, as extracted from video images and stored in the local memory unit. If the travel-behavior diagnosis of the vehicle is identical to the travel-behavior features of a vehicle, i.e. if the vehicle is detected, the vehicle is labeled and is continuously tracked by an object tracking module.

The object tracking module is adapted to track a vehicle after being detected until reaching a parking space, during parking in the parking space and until the vehicle leaves the parking space. Once the system detects that the vehicle has reached a parking space and has parked, the vehicle is recognized as parking and an initial visual descriptor model is generated, describing the vehicle in the parking space.

During the parking, two image-based processes take place in parallel in order to determine whether or not the vehicle is still parking. One process comprises continuously monitoring the parking space and comparing, online visual descriptor features of the current state of the parking space with a visual descriptor of the parking space occupied by the vehicle. Another process comprises periodically updating a reference visual descriptor describing the vehicle in the parking space as to accommodate changes in images of the parking space which do not relate to the vehicle leaving the parking space, e.g. lighting changes as a result of nightfall.

Once the current state of the parking space and the occupied parking space do not match, i.e. the comparison yields inequality between the two, the vehicle is recognized as not parking. The vehicle can further be tracked by the object tracking module.

According to an embodiment of the invention, when activating the software application, a user is able to insert a request to the system. The request can be directions to a vacant parking space close to a destination. Accordingly the user is required to insert the destination and insert a request for detecting and receiving directions to a vacant parking space.

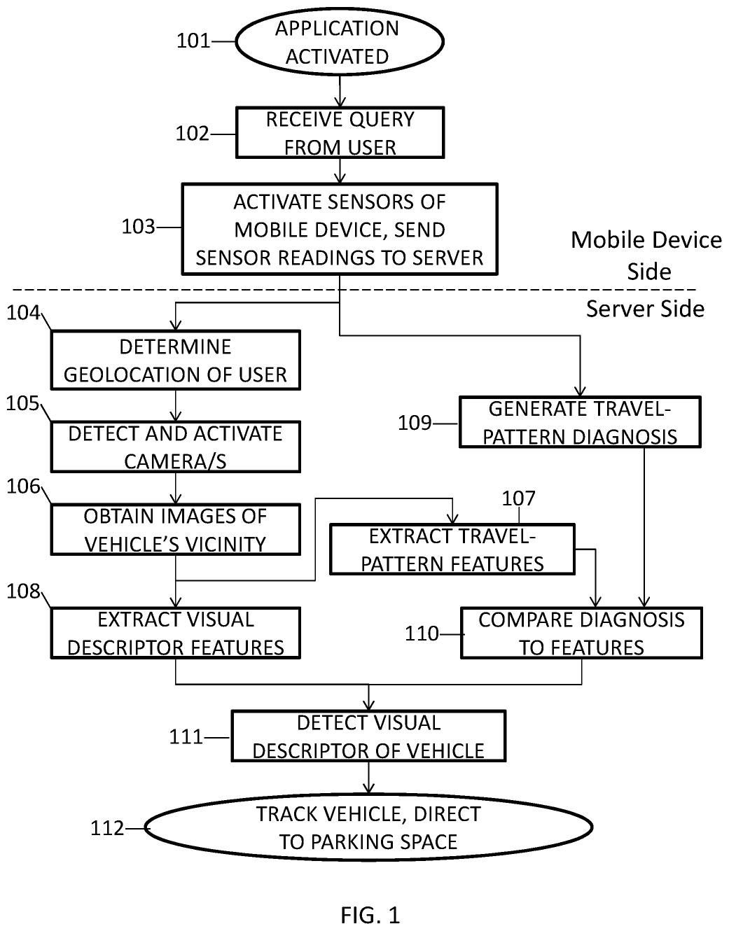

FIG. 1 shows a flowchart 100 describing the process of providing directions to a vacant parking space, according to an embodiment of the invention. A dashed line divides the flowchart to an upper section and a lower section. Steps in the upper section are performed on the mobile device side, while steps in the lower section are performed on the server side. In the first step 101, a user activates a software application associated with the invention. In the next step 102, the user inserts a vacant parking space query comprising the user's destination and a request for a vacant parking space. Next, in step 103 the software application causes sensors of the mobile device to be activated and sends readings from the sensors to the remote server. According to an embodiment of the invention the sensors activated include a GPS receiver and an accelerometer. Once readings are received by the server, in step 104 the geolocation of the user and the vehicle is determined according to readings of the GPS receiver of the mobile device. In the next step 105, the GIS of the remote server is searched for one or more video cameras whose field of view includes the geolocation of the vehicle, and the one or more detected video cameras are activated. In the next step 106, images are obtained by the one or more video cameras, the images including the user's vehicle. The images are processed in step 107 and travel-pattern features of every vehicle in the images are extracted. In addition the images are processed in step 108 wherein visual descriptor features of the vehicles in the images are extracted. The visual descriptor features of each vehicle in the images are associated with the travel-pattern features of the vehicle.

In parallel to steps 104-108, once the sensor readings are received by the server, a travel-pattern diagnosis of the user's vehicle is generated by the processor in step 109. An example of a travel-pattern diagnosis is shown hereinabove, in table 1. In step 110 the travel-pattern diagnosis generated in step 109 is compared to the travel-pattern features extracted in step 107. After detecting the travel-pattern features which match the travel-pattern diagnosis, in step 111 the visual descriptor features associated with the detected travel-pattern features are recognized as representing the user's vehicle. This recognition is used in step 112 in which the vehicle is continuously tracked, and the user is provided with directions to a parking space by continuously updating the geolocation of the vehicle.

The visual descriptor features recognized in step 111 of flowchart 100 are updated periodically and can be used as the initial visual descriptor model of a parking vehicle.

According to an embodiment of the invention, data regarding the parking state of a vehicle is used for providing services. An example of a service is charging a user a parking fee for parking in a pay-and-park parking space. Another example of a service is detection of a vehicle parking in a prohibited parking space, and providing the detection for law enforcement needs, for instance issuing a parking ticket.

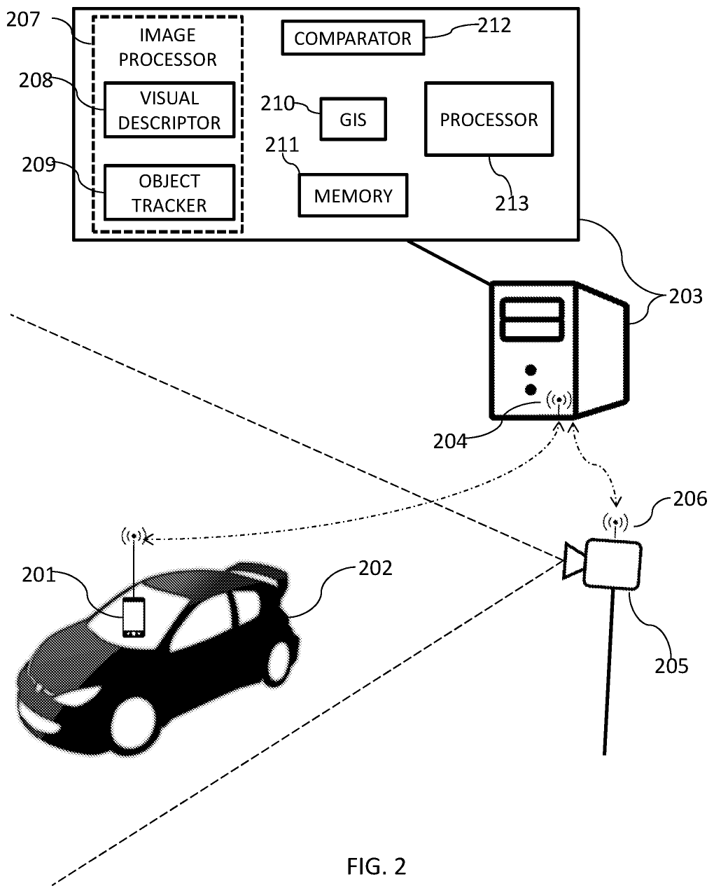

FIG. 2 schematically illustrates a system for detecting a vehicle according to an embodiment of the invention. In FIG. 2 a user's mobile device 201 is inside vehicle 202, the mobile device comprising a software application adapted to obtain readings from sensors of the mobile device and to send the readings to a remote server. Camera 205 is provided in order to obtain images of vehicle 202. The field of view, illustrated in FIG. 2 as the area between two straight dashed lines, of camera 205 includes at least vehicle 202. Camera 205 comprises communication hardware 206 for transmitting images to a remote server. Remote server 203 comprises: communication hardware 204 for communicating with other components of the system; an image processing unit 207 being a software module for identifying a vehicle from images received from one or more cameras, the image processing module comprising a visual descriptor software module 208 for extracting visual descriptor features of vehicles and an object tracking software module 209 for detecting travel-pattern features of vehicles. Remote server 203 further comprises a Geographic Information System (GIS) 210 for recognizing the geolocation of vehicles at various stages of parking; a memory unit 211 adapted to store travel-pattern features; a comparator module 212 adapted to compare data from multiple sources; and a processing unit 213 for processing sensor readings, images and other previously processed data and generating other contextual data which is of significance to vehicle detection (e.g. generating travel-patterns).

As various embodiments have been described and illustrated, it should be understood that variations will be apparent to one skilled in the art without departing from the principles herein. Accordingly, the invention is not to be limited to the specific embodiments described and illustrated in the drawings.

1. A method for detecting and tracking a traveling vehicle, comprising:
a) receiving readings from one or more sensors of a mobile device that are relative to travel-pattern features of said traveling vehicle, including geolocation data;
b) processing the received readings as to generate travel-pattern diagnosis of said traveling vehicle;
c) receiving images, from one or more cameras, of a driving area in accordance with the geolocation of said traveling vehicle, wherein said one or more cameras are distributed throughout said driving area;
d) identifying vehicles that appear in said received images by extracting visual descriptor features of said appeared vehicles and detecting travel-pattern features of said appeared vehicles; and
e) comparing the detected travel-pattern features of one or more appeared vehicle with the generated travel-pattern diagnosis of said traveling vehicle for finding travel-pattern features of a vehicle which match the travel-pattern diagnosis, whereupon detection of a vehicle whose travel-pattern features match the travel-pattern diagnosis the vehicle is labeled and tracked.

2. A method according to claim 1, wherein the readings from the one or more sensors of the mobile device are received whenever the traveling vehicle approaches a predetermined destination.

3. A method according to claim 1, wherein each camera having a field of view that includes at least a street, a road or a way of the driving area.

4. A system for detecting and tracking a traveling vehicle, comprising:
a) a software application for mobile devices adapted to obtain readings from sensors of the mobile device and to send the readings to a remote server;
b) one or more video cameras distributed throughout a driving area, each camera having a field of view, the field of view comprising at least a street, a road or a way of the driving area, the one or more cameras comprising communication hardware for transmitting images to a remote server; and
c) a remote server comprising:
i. communication hardware for communicating with mobile devices;
ii. an image processor being a software module for identifying a vehicle from images received from one or more cameras, the image processor comprising a visual descriptor software module adapted to extract visual descriptor features of vehicles and an object tracker adapted to detect travel-pattern features of vehicles;
iii. a Geographic Information System (GIS) being a software module adapted to recognize the geolocation of vehicles;
iv. a memory unit;
v. a comparison module being a software module adapted to compare data from a plurality of sources; and
vi. a processing unit adapted to process non-contextual data and generate contextual data which is of significance to vehicle detection.
wherein upon activation of the software application by a user, sensors of the mobile device are activated and readings of the sensors are transferred to the remote server, the remote server receives the sensor readings, processes the readings by the processing unit and generates travel-pattern diagnosis; and wherein the remote server detects the geolocation of the vehicle from the sensor readings and accordingly obtains images from one or more video cameras located in the vicinity of the vehicle, after which the visual descriptor generates travel-pattern features of vehicles from the images, and the travel-pattern features are stored on the memory unit; and wherein the travel-pattern features of each vehicle are searched, by the comparison module, for travel-pattern features of a vehicle which match the travel-pattern diagnosis, whereupon detection of a vehicle whose travel-pattern features match the travel-pattern diagnosis the vehicle is labeled and tracked by the object tracker.

5. A system according to claim 4, wherein a user is able to insert a request to the system, the request comprising directions to a vacant parking space; and wherein cameras and the processor of the system are utilized to detect a vacant parking space and the GIS is utilized to provide directions to the vacant parking space.

6. A system according to claim 4, wherein the sensors activated by the software application include at least GPS receiver and an accelerometer.

7. A system according to claim 4, wherein the parking state and location of a vehicle is utilized for charging a user a parking fee for parking in a pay-and-park parking space.

8. A system for detecting and tracking a vehicle approaching a parking space and parking in a parking space, comprising:
a) the system of claim 4 adapted to detect and track a traveling vehicle; and
b) one or more video cameras distributed throughout one or more parking areas, each camera having a field of view, the field of view comprising at least a portion of a parking area, the one or more cameras comprising communication hardware for transmitting images to the remote server;
wherein the field of view of the one or more video cameras distributed throughout the driving area comprises at least a route to the parking area; and wherein the labeled vehicle is continuously tracked until parking reaching a parking space; and wherein images of the parking space are obtained while the vehicle is parking and online visual descriptor features of the parking space extracted from the images are compared online to periodically updated visual descriptor reference features of the vehicle in the parking space, wherein inequality between the reference features and the online features yields the vehicle has left the parking space.

9. A system according to claim 5, wherein a vehicle is tracked until the vehicle leaves a parking space.

10. A system according to claim 5, wherein a vehicle is tracked until the user stops the software application.

11. A system according to claim 5, wherein a user is able to insert a request to the system, the request comprising directions to a vacant parking space; and wherein cameras and the processor of the system are utilized to detect a vacant parking space and the GIS is utilized to provide directions to the vacant parking space.

12. A system according to claim 5, wherein the sensors activated by the software application include at least GPS receiver and an accelerometer.

13. A system according to claim 5, wherein the parking state and location of a vehicle is utilized for detecting a vehicle parking in a prohibited parking space.
